(19) United States
(12) Patent Application Publication
(10) Pub. No.: US 2017/0208106 A1
(43) Pub. Date: Jul. 20, 2017

(54) INTEGRAL CONTROLLER BASED PACING FOR HTTP PSEUDO-STREAMING

(71) Applicant: Affirmed Networks, Inc., Acton, MA (US)

(72) Inventors: Jae CHUNG, Lexington, MA (US); Srinivasan VENKATRAMAN, Belmont, MA (US); Paul SHERER, Danville, CA (US)

(21) Appl. No.: 15/480,087

(22) Filed: Apr. 5, 2017

Related U.S. Application Data
(63) Continuation of application No. 13/453,708, filed on Apr. 23, 2012.

(51) Int. Cl. H04L 29/06; H04N 21/845; H04N 21/218; H04L 29/08; H04N 21/643

(52) U.S. Cl. CPC H04L 65/4092; H04L 67/02; H04L 65/4084; H04L 65/605; H04L 65/80; H04N 21/64322; H04N 21/2181; H04N 21/8456

(57) ABSTRACT

Methods and apparatus, including computer program products, for integral controller based pacing for HTTP pseudo-streaming. A method includes receiving a request portions of a multimedia clip residing in the content server from a media player residing in the user equipment and delivering the requested portions of the multimedia clip to the media player while maintaining a target bitrate in a presence of control noises in the network. Delivering the requested portions of the multimedia clip can include estimating a target transmission rate, determining a target elasticity buffer, and estimating a number of bytes to send in a current transmission epoch.

### BACKGROUND OF THE INVENTION

The invention generally relates to communication networks, and more specifically to integral controller based pacing for Hypertext Transfer Protocol (HTTP) pseudo-streaming.

The biggest advantage of streaming over download is the ability to seek in the timeline to positions that have not been downloaded yet to the player. This is most desirable for full-length movies because the visitor can seek to the last scene of a 2-hour movie if she wants to. HTTP pseudo-streaming combines the advantages of straight HTTP downloads (e.g., it passes any firewall, viewers on bad connections can simply wait for the download) with the ability to seek to non-downloaded parts.

HTTP pseudo-streaming uses Transmission Control Protocol (TCP), designed originally for bulk data transfers, as transport protocol. As such, TCP does not explicitly indicate the timing information of the media in the payload. TCP is used to merely transfer a media clip (such as, e.g., .flv or .mp4 files). The media time information is implicitly sent within the media clip format, and the player simply plays back the clip as portions of it are downloaded.

HTTP pseudo-streaming uses HTTP to control the streaming media download over TCP. The streaming clients often provide the desired media seek position information as an URL option in the HTTP request, which is handed over to the pseudo-streaming server by the HTTP. The pseudo-streaming server uses the information to prepare a media clip that plays from the desired seek position and transmit via HTTP.

HTTP pseudo-streaming, relying the streaming media transmission solely on TCP, is incapable of maintaining a desirable target streaming bitrate, but often delivers the media to the client at the available link speed that is often much higher than the target bitrate. This could result in waste of the bandwidth when the viewer lost interest in the media and stop the transmission. Thus, a transmission pacing mechanism to control the media transmission rate to a desirable bitrate is highly desirable for HTTP pseudo-streaming.

In general, rate control is essential for media streaming over packet networks. The challenge in delivering bandwidth-intensive content like multimedia over capacity-limited, shared links is to quickly respond to changes in network conditions by adjusting the bitrate and the media encoding scheme to optimize the viewing and listening experience of the user. In particular, when transferring a media stream over a connection that cannot provide the necessary throughput, several undesirable effects arise. For example, a network buffer may overflow, resulting in packet loss causing garbled video or audio playback, or a media player buffer may underflow resulting in playback stall.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for integral controller based pacing for HTTP pseudo-streaming.

In general, in one aspect, the invention features a method including, in a network including user equipment linked to an integral controller based pacing for Hypertext Transfer Protocol (HTTP) streaming manager and a content server, receiving a request portions of a multimedia clip residing in the content server from a media player residing in the user equipment and delivering the requested portions of the multimedia clip to the media player while maintaining a target bitrate in a presence of control noises in the network. Delivering the requested portions of the multimedia clip can include estimating a target transmission rate, determining a target elasticity buffer, and estimating a number of bytes to send in a current transmission epoch.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is a block diagram.

FIG. 3 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” “subscriber station,” “communication device,” “access terminal,” “terminal,” “handset,” and similar terminology, refer to a wireless device (e.g., cellular phone, smart phone, computer, personal digital assistant (PDA), set-top box, Internet Protocol Television (IPTV), electronic gaming device, printer, etc.) utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B (HNB),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” and the like are employed interchangeably throughout the subject specification, unless context warrants particular distinction(s) among the terms.

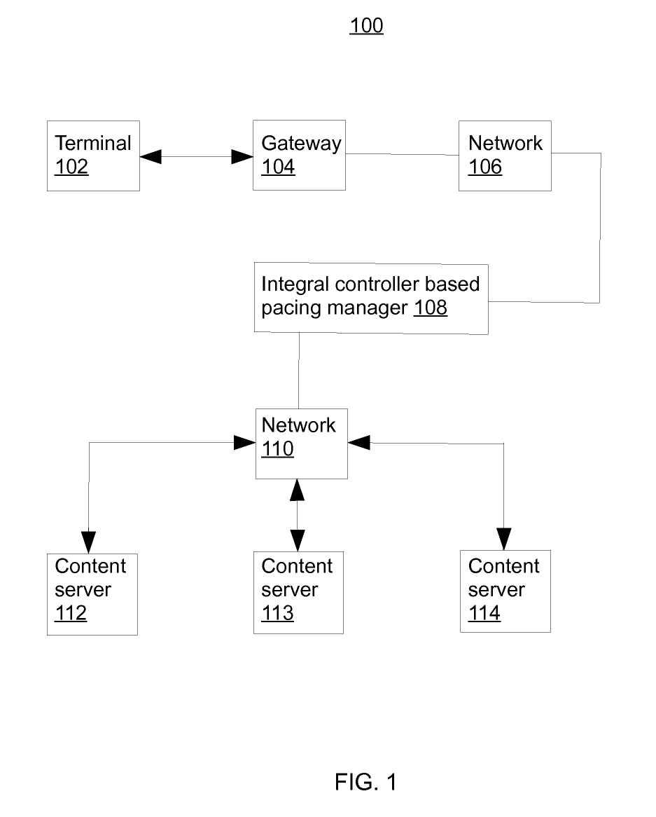

As shown in FIG. 1, an exemplary system 100 includes, among other things, a terminal 102, a gateway 104, one or more networks 106, 110, an integral controller based pacing manager 108, and one or more content servers 112-114.

Terminal 102 is a hardware component including software applications that enable terminal 102 to communicate and receive packets corresponding to streaming media.

Terminal 102 provides a display and one or more software applications, such as a media player, for displaying streaming media to a user of terminal 102. Further, terminal 102 has the capability of requesting and receiving data packets, such as data packets of streaming media, from the Internet. For example, terminal 102 can send request data to content servers 112-114 for a particular file or object data of a web page by its universal resource locator (URL), and the content server of the web page can query the object data in a database and send the corresponding response data to terminal 102. In some embodiments, response data may be routed through integral controller based pacing manager 108.

While terminal 102 can be a wired terminal, embodiments of the invention may include using a mobile terminal because mobile terminals are more likely to be in networks that would benefit more from the integral controller based pacing manager 108. The network connection in a mobile network tends to be less stable as compared to wired network connection due to, for example, the changing position of the mobile terminal where data rate transmissions between the mobile terminal and the network can fluctuate, in some cases quite dramatically.

Gateway 104 is a device that converts formatted data provided in one type of network to a particular format required for another type of network. Gateway 106, for example, may be a server, a router, a firewall server, a host, or a proxy server. Gateway 104 has the ability to transform the signals received from terminal 102 into a signal that network 106 can understand and vice versa. Gateway 104 may be capable of processing audio, video, and T.120 transmissions alone or in any combination, and is capable of full duplex media translations.

Networks 106 and 110 can include any combination of wide area networks (WANs), local area networks (LANs), or wireless networks suitable for packet-type communications (e.g., GSM, CDMA, LTE, WiMAX, and so forth), such as Internet communications. Further, networks 106 and 110 can include buffers for storing packets prior to transmitting them to their intended destination.

Integral controller based pacing manager 108 is a server that provides communications between gateway 104 and content servers 112-114. Integral controller based pacing manager 108 maintains a target bitrate in average in presence of control noises such as transient network congestion or inconsistent packet scheduling epoch at the content servers 112-114. In one particular embodiment, the integral controller based pacing manager 108 is implemented in AN-3000 Proxy Cache manufactured by Affirmed Networks, Inc., of Acton, Mass.

Content servers 112-114 are servers that receive the request data from terminal 102, process the request data accordingly, and return the response data back to terminal 102 through, in some embodiments, integral controller based pacing manager 108. For example, content servers 112-114 can be a web server, an enterprise server, or any other type of server. Content servers 112-114 can be a computer or a computer program responsible for accepting requests (e.g., HTTP, RTSP, or other protocols that can initiate a media session) from terminal 102 and serving terminal 102 with streaming media.

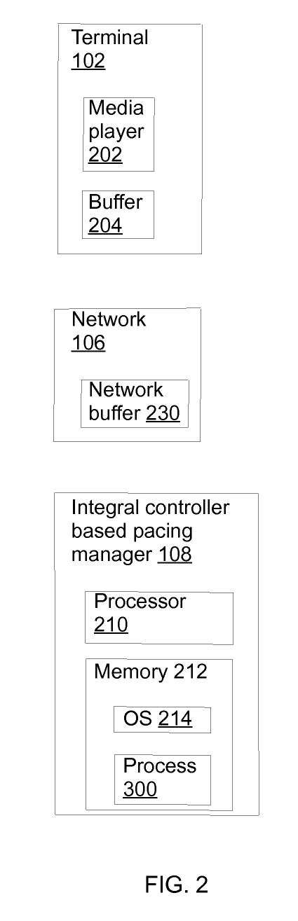

As shown in FIG. 2, terminal 102 may include, among other things, a media player 202 and a buffer 204. Integral controller based pacing manager 108 can include, among other things, a processor 210 and a memory 212. Memory 212 can include an operating system 214, such as Linux®, Unix® or Windows®, and a integral controller based pacing for HTTP pseudo-streaming process 300.

Media player 202 is computer software for playing multimedia files (such as streaming media) including video and/or audio media files. Examples of media player 202 can include Microsoft® Windows Media Player, Apple® Quicktime® Player, RealOne® Player, and Adobe® Flash Plugin for web-embedded video. In some embodiments, media player 202 decompresses the streaming video or audio using a codec and plays it back on a display of terminal 102. Media player 202 can be used as a standalone application or embedded in a web page to create a video application interacting with HTML content. Further, media player 202 can provide feedback on media reception to the integral controller based pacing manager 108 in the form of media receiver reports. Media receiver reports can include RTCP packets for an RTP streaming session, or TCP ACKs for a pseudo-streaming session.

Buffer 204 (also known as terminal buffer 204) is a software program and/or a hardware device that temporarily stores multimedia packets before providing the multimedia packets to media player 202. In some embodiments, buffer 204 receives the multimedia packets from integral controller based pacing manager 108 via network 106. In some embodiments, buffer 204 receives the multimedia packets from a device other than integral controller based pacing manager 108. Once buffer 204 receives multimedia packets (or portions of a media clip if pseudo-streaming), it can provide the stored multimedia packets to media player 202. While terminal buffer 204 and media player 202 are shown as separate components, in other implementations the terminal buffer 204 can be a part of media player 202. Further, while only a single buffer, implementations may include multiple buffers, for example, one or more buffers for audio media packets and one or more buffers for video media packets.

HTTP Pseudo-streaming refers to a transmission technic wherein an audio/video content that can be played before the entire content is transmitted as a single HTTP object. It is desirable to pace the media transmission at a certain bitrate close to the encoded bitrate of the media after initial media buffering period especially for wireless networks, since airlink resource is expensive and it is likely that the media presentations may be cancelled by the user as he/she loses interest in the content before the end of the presentation.

The integral controller based pacing for HTTP pseudo-streaming process 300 is a packet transmission pacing technique that can be used by a media server or proxy to maintain a target bitrate in average in presence of control noises such as transient network congestion or inconsistent packet scheduling epoch at the server.

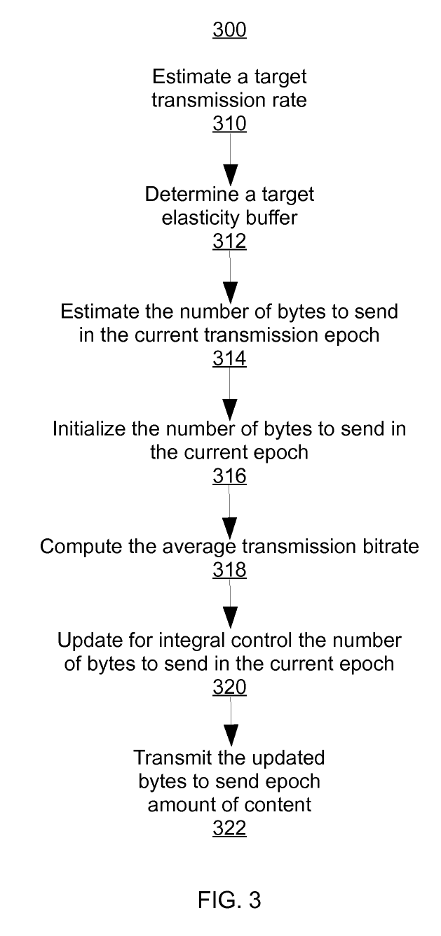

As shown in FIG. 3, process 300 includes estimating (310) a target transmission rate. Target transmission rate estimation requires information about a size and time duration of the multimedia content, which can be obtained by parsing the media container. In case the size or time duration is not available (as for live contents), the media encoding bitrate informed in the container header can be used as the target transmission rate. The target transmission rate may be calibrated by applying a factor greater than 1 to make the transmission of the media slightly faster than the presentation speed to avoid halt in the media presentation due to unstable network conditions.

Process 300 determines (312) a target elasticity buffer. The amount of content as measured in display time that has been acknowledged by a client minus a wall clock time required to deliver it can be considered the display elasticity buffer. In this case, there are always two targets. i.e., a transmission rate target and a receiver elasticity target. During an initial buffer fill, the transmission rate target is typically be higher than once the elasticity target is initially met.

The target elasticity buffer may be set based on a variety of parameters, such receiving device type and subscriber type. Further, a transmission channel can be characterized to its stability of delivery. If the channel is less stable then the target elasticity buffer for the particular receiver may be increased. Comparing regular samples of transmission throughput trends can be developed and used to adjust the target elasticity buffering. For example, if the apparent receiver elasticity is decreasing then the transmission rate may be slightly increased. If increasing the transmission rate does not improve elasticity (or at least slow the decline) then there may be no reason for further transmission rate increases.

Once the target transmission bitrate (target_bitrate) is determined, process 300 estimates (314) the number of bytes to send in the current transmission epoch using an integral controller as follows.

Process 300 initializes (316) the number of bytes to send in the current epoch (bytes_to_send_epoch) to a value obtained by the target bitrate times the estimated epoch length and start transmission. In each epoch,

(a) The average transmission bitrate is (average bitrate) computed as the total number of transmitted bytes divided by the elapse time after the transmission of the first byte.

(b) Update for integral control the number of bytes to send in the current epoch as follows:

bytes_to_send_epoch+=INTEGRAL_CONST (target_bitrate−average_bitrate)
if (bytes_to_send_epoch>BYTES_EPOCH_MAX)
   bytes_to_send_epoch=BYTES_EPOCH_MAX
if (bytes_to_send_epoch<BYTES_EPOCH_MIN)
   bytes_to_send_epoch=BYTES_EPOCH_MIN

BYTES_EPOCH_MAX can be set to initial bytes_to_send_epoch times a factor greater than 1, and BYTES EPOCH MIN can be set to initial bytes_to_send_epoch times a factor less than 1.

(c) Transmit the updated bytes_to_send_epoch amount of content.

Process 300 includes one or more of the following advantages. Process 300 is useful when there is no network level throttling like TCP. One strength of process 300 is that it is resilient to any small control noise from the server or network to achieve the average target bitrate.

Process 300 is useful for media servers/proxy facing a wireless network where transient airlink congestion is common.

Various implementations of the systems and techniques described here can be realized in digital electronic circuitry, integrated circuitry, specially designed ASICs (application specific integrated circuits), computer hardware, firmware, software, and/or combinations thereof These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A method comprising:
in a network comprising user equipment linked to an integral controller based pacing for Hypertext Transfer Protocol (HTTP) streaming manager and a content server, receiving a request portions of a multimedia clip residing in the content server from a media player residing in the user equipment; and
delivering the requested portions of the multimedia clip to the media player while maintaining a target bitrate in a presence of control noises in the network.

2. The method of claim 1 wherein the media player is designed to play the delivered portions of the multimedia clip.

3. The method of claim 1 wherein the network is selected from the group consisting of a wide area network (WAN), a local area network (LAN), a Global System for Mobile Communications (GSM) network, a Code Division Multiple Access (CDMA) network, a Long Term Evolution (LTE) network and a Worldwide Interoperability for Microwave Access (WiMax) network.

4. The method of claim 1 wherein the user equipment is selected from the group consisting of a smart phone, a cellular phone, a computer, a personal digital assistant (PDA), a set-top box, an Internet Protocol Television (IPTV), an electronic gaming device, a tablet and a Wi-Fi hotspot.

5. The method of claim 1 wherein delivering the requested portions of the multimedia clip comprises:
estimating a target transmission rate;
determining a target elasticity buffer; and
estimating a number of bytes to send in a current transmission epoch.

6. The method claim 5 wherein estimating the target transmission rate comprises parsing a media container to obtain information about a size and time duration of the portions of a multimedia clip.

7. The method of claim 5 wherein estimating the target transmission rate comprises a media encoding bitrate informed in a container header.

8. The method of claim 5 wherein determining the target elasticity buffer comprises an amount of multimedia clip content measured in display time that has been acknowledged by the user equipment minus a wall clock time required to deliver it.

9. The method of claim 5 wherein estimating the number of bytes to send in the current transmission epoch comprises initializing a number of bytes to send in the current epoch to a value obtained by the target bitrate times the estimated epoch length and start transmission.

10. The method of claim 9 further comprising:
in each epoch, computing an average transmission bitrate as a total number of transmitted bytes divided by the elapse time after a transmission of a first byte;
updating for integral control the number of bytes to send in the current epoch; and
transmitting the updated bytes to send epoch amount of multimedia content.

11. An integral controller based pacing server comprising:
a processor;
a memory, the memory including an operating system and an integral controller based pacing for Hypertext Transfer Protocol (HTTP) streaming process, the process comprising:
delivering requested portions of a multimedia clip to a media player while maintaining a target bitrate in a presence of control noises in a network.

12. The server of claim 11 wherein delivering the requested portions of the multimedia clip comprises:
estimating a target transmission rate;
determining a target elasticity buffer; and
estimating a number of bytes to send in a current transmission epoch.

13. The server claim 12 wherein estimating the target transmission rate comprises parsing a media container to obtain information about a size and time duration of the portions of a multimedia clip.

14. The server of claim 12 wherein estimating the target transmission rate comprises a media encoding bitrate informed in a container header.

15. The server of claim 12 wherein determining the target elasticity buffer comprises an amount of multimedia clip content measured in display time that has been acknowledged by the user equipment minus a wall clock time required to deliver it.

16. The server of claim 12 wherein estimating the number of bytes to send in the current transmission epoch comprises initializing a number of bytes to send in the current epoch to a value obtained by the target bitrate times the estimated epoch length and start transmission.

17. The server of claim 16 wherein the process further comprises:
in each epoch, computing an average transmission bitrate as a total number of transmitted bytes divided by the elapse time after a transmission of a first byte;
updating for integral control the number of bytes to send in the current epoch; and
transmitting the updated bytes to send epoch amount of multimedia content.
